(19) United States
(12) Patent Application Publication
(10) Pub. No.: US 2014/0156449 A1
(43) Pub. Date: Jun. 5, 2014

(54) METHOD AND APPARATUS FOR ITEM RECOMMENDATION

(71) Applicant: EMBL RETAIL INC., West Sacramento, CA (US)

(72) Inventors: Anand GANESAN, Bangalore (IN); Shabari RAJE, Mumbai (IN); Mukul KELKAR, West Sacramento, CA (US)

(73) Assignee: EMBL RETAIL INC., West Sacramento, CA (US)

(21) Appl. No.: 14/094,020

(22) Filed: Dec. 2, 2013

Related U.S. Application Data
(60) Provisional application No. 61/732,398, filed on Dec. 2, 2012.

(51) Int. Cl. G06Q 30/06

(52) U.S. Cl. CPC G06Q 30/0631
USPC 705/26.7

(57) ABSTRACT

The present invention provides a method and system for recommending one or more products and recommending one or more sales channel to a user. The method and apparatus disclosed provides a mechanism for generating a personalized and customized catalog of relevant products to be presented to the user along with a plurality of sales channels showing availability of the recommended products. Various embodiments of the present invention teaches a mechanism for generating the product recommendation based on at least the user shopping context information, user preference information, and the body profile information. The one or more products are correlated with the user information and the most relevant products are recommended to the user. The invention also teaches a method for virtually trying a product recommended by the recommendation engine of the present invention before purchasing through the one or more recommended sales channels.

### CROSS REFERENCE TO RELATED APPLICATIONS

This application claims the benefit of U.S. Provisional Patent Application Ser. No. 61/732, 398 filed Dec. 2, 2012, entitled “RECOMMENDATION SYSTEM TO PROVIDE RIGHT PRODUCT AND SALES CHANNEL FOR THEIR SHOPPING CONTEXT,” the entirety of which is herein incorporated by reference.

### FIELD OF INVENTION

The present invention relates to data acquisition, information search and recommendation systems and in particular, this invention relates to method and system for recommending relevant products to an individual user.

### BACKGROUND

It is often necessary to make choices without sufficient personal experience of alternatives. In everyday life, people rely on recommendations from other people either by word of mouth, reviews printed on newspapers, online recommendation based on the rating and reviews from experts, users and the like.

Online recommendation of a product has gained popularity due to the growth of internet, advancement in technologies, and the need for retailers to reach consumers directly. Individuals browsing through a given collection can have a difficult time for efficiently locating products that are ideal choices for their shopping context. Such difficulty increases with the increase in the collection of products. Accordingly, an online or an in-store digital recommendation system is desirable to assist the individual in locating product of interest. Existing online recommendation systems predict the products of interest for a user by collecting preferences from many users with similar interest. Though the prediction is specific to the individual user, the information is retrieved based on aggregated inputs from many users present in the database of the online recommendation system.

The online recommendation system is used in variety of applications such as electronic products, books, accessories, apparels, footwear and the like. However, it is difficult to recommend lifestyle product that are wearable such as apparels and footwear using only user preferences and fitting records of the user. As every model and brand has it's own interpretation of size, it is hard to recommend a product size without physical trial of the product and without having to take measurements of foot or body every time.

The conventional online recommendation systems for wearable items recommend products based on traditional sizing scheme. For example, if an individual enters his size as 8.5 in men's category, the online recommendation system displays all the items listed in the database with the size 8.5 in men's category. One problem with the conventional sizing scheme is that it is a single dimensional sizing system to represent a 3-dimensional body parts such as a foot and therefore does not take into account several other parameters key to fitting a product on the user. Further, the product manufacturers use this single numeral sizing system to design footwear or apparels that has more than 10-20 measurements. These measurements are designer's interpretation based on the product's usage, target segment, demographic data, fashion etc and therefore differ for every manufacturer, from brand to brand and model to model with in the same brand. Additionally, in the conventional methods, the individual user is not provided with any provisions to know the way the recommended item looks on her or how the item fits on her

In light of the above discussion, there is a need for a system and method that overcomes the above disadvantages.

### BRIEF DESCRIPTION OF FIGURES

FIG. 1 illustrates environment in which the product and sales channel recommendation is made, in accordance with various embodiments of the present invention;

FIG. 2 illustrates a block diagram of a recommendation system, in accordance with various embodiments of the present invention;

FIG. 3 illustrates components of recommendation engine, in accordance with various embodiments of the present invention;

FIG. 4 illustrates a flowchart for recommending products and sales channel to a user, in accordance with various embodiments of the present invention; and

FIG. 5 illustrates a block diagram of a computer server system, in accordance with various embodiments of the present invention.

### BRIEF DESCRIPTION OF THE INVENTION

The above-mentioned shortcomings, disadvantages and problems are addressed herein which will be understood by reading and understanding the following specification.

The present invention provides a method and system for recommending one or more products and recommending one or more sales channels to the user. The method comprises steps of making the user verbalize the shopping context by providing one or more personal preferences and shopping needs, creating a customized catalog of products correlating with the shopping context and user preferences identified in the previous step. Further, the method comprises the steps of providing an interface to the user for comparing a plurality of suggested products, providing an interface to virtually try the product and suggesting one or more sales channel that carry the inventory in real time for the selected products. The user preferences include but are not limited to the digitized body image of the user, preference for or against a make, design, material & construction, preference on usage, preference on features, and geo-location of the user. The method and system further includes presenting a trial room for users to try one or more recommended products.

The system and apparatus for recommending relevant products to the user comprises a recommendation engine communicatively connected to a user database. The recommendation engine is configured to collect user preferences, identify and record the user shopping context. The recommendation engine is further in communication with a product database and a retailer database. The recommendation engine of the present invention is also configured to receive inputs from a social media inputs module and feedback collection module. In addition to the products, the system and method provides the recommendation of retail channel/store to complete the purchase.

Systems and methods of varying scope are described herein. In addition to the aspects and advantages described in this summary, further aspects and advantages will become apparent by reference to the drawings and with reference to the detailed description that follows.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

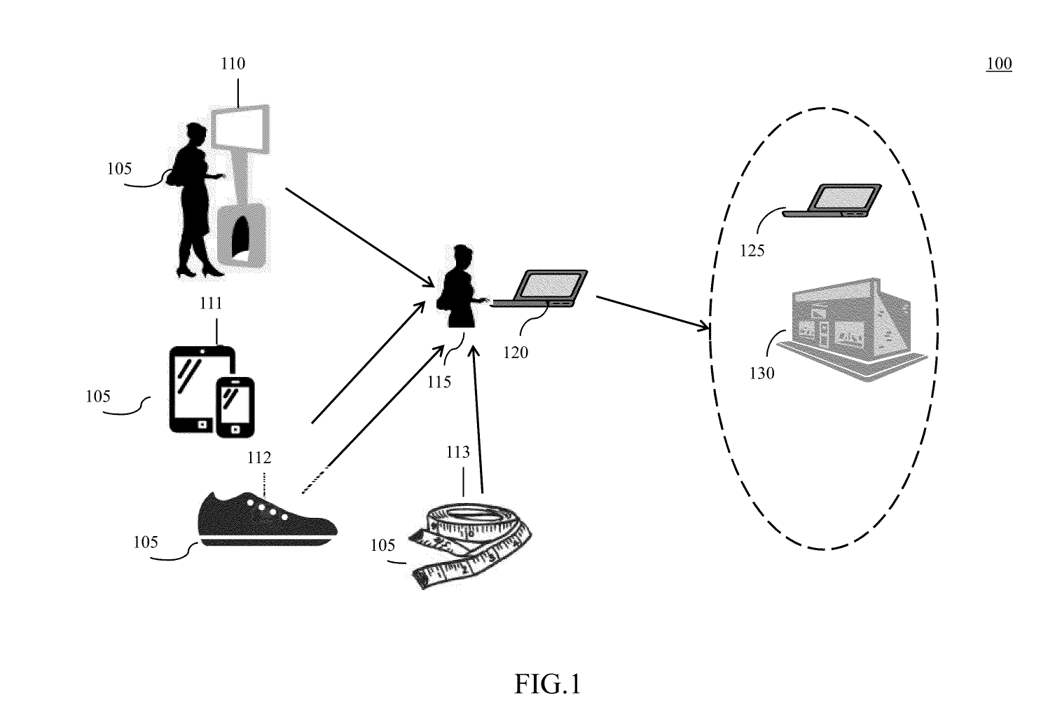

FIG. 1 illustrates environment 100 in which the product and sales channel recommendation is made, in accordance with various embodiments of the present invention. The environment 100 includes a user 105 who wants to get her body profile digitized for using recommendation service. System 100 also includes a kiosk 110 from where the user 110 can get her body profile digitized. The user 105 gets her body profile digitized in the nearest available kiosk 110. A kiosk 110 is a small open-fronted but or cubicle from where the user can get her body profile digitized. In an embodiment, the user 105 gets her feet profile digitized in the kiosk. In another embodiment, the user 105 gets her hand profile digitized in the kiosk 110. In yet another embodiment, the user 105 gets any other body party or the whole body profile digitized in the kiosk 110. The kiosk 110 generates a unique identity for each digitized profile. In an embodiment, the unique identity generated by the kiosk 110 is a set of numerical characters. In another embodiment, the unique identity generated by the kiosk 110 is a set of alphabets. In yet another embodiment, the unique identity generated by the kiosk 110 is a combination of alphabets and numerical characters. The kiosk 110 generates unique identity based on various algorithms. In an embodiment, the kiosk 110 generates unique identity randomly under given set of conditions. In another embodiment, the kiosk 110 generates unique identity based on different encryption algorithms.

In one embodiment, the system 100 further includes a profiler application 111 installed on a computing device 120 associated with the user 110. The profiler application 111 is configured to create digital profile of the user 110. The computing device 120 is any internet connectable device such as laptop, mobile phone or tablet computer. The computing device 120 may further have any special hardware device attached for the purpose of this invention. In another embodiment, the profiler application 111 is configured to run as a plugin on the computing device 120. In yet another embodiment, the profiler application is configured to run as a web application on the computing device 120.

In one embodiment, the user 105 uses the profiler application 111 to click photographs in a specified manner of any or all body parts and which will be used to create a digital profile. The profiler application 111 generates a unique identity for each digitized profile. In an embodiment, the unique identity generated by the profiler application 111 is a set of numerical characters. In another embodiment, the unique identity generated by the profiler application 111 is a set of alphabets. In yet another embodiment, the unique identity generated by the profiler application 111 is a combination of alphabets and numerical characters. The profiler application 111 generates unique identity based on various algorithms. In an embodiment, the profiler application 111 generates unique identity randomly under given set of conditions. In another embodiment, the profiler application 111 generates unique identity based on different encryption algorithms.

In yet another embodiment, the kiosk 110 or the profiler application 111 are configured to receive the digital profile of the user by providing a product proxy (112) as shown in FIG. 1. The kiosk 110 and/or, the profiler application 111 receive the proxy product(112) information such as for e.g. details of a footwear that the user is comfortable in, size, color of a pair of jeans and the like. Based on the information received on the proxy product(112), a unique identity number is assigned to the user and stored in the storage means.

In yet another embodiment of the present invention, the kiosk 110 and the profiler application 111 are further configured to create digital profile of the user based on the physical dimensions provided by user manually such as by using a measuring tape etc. The kiosk 110 and the profiler application 111 are configured to convert the measures input by users into standard units and create a unique code. The user digital profile along with the unique code is further stored in the storage means.

Further, the system 100 includes a user 115 who is using the recommendation service through a computing device 120. In the context of present invention the user 105 and the user 110 are the same. In an embodiment, the computing device 120 is a desktop computer. In another embodiment, the computing device 120 is a laptop computer. In yet another embodiment, the computing device 120 is a tablet computer. In yet another embodiment, the computing device 120 is a smart-phone. In yet another embodiment, the computing device 120 is a phone capable of connecting to internet.

Further, the system 100 shows the user 115 entering her unique identity along with user preferences & shopping context in the computing device 120. The user 115 can enter detailed information based on personal preferences, current shopping and product attributes. In an embodiment, the user 115 enters her unique identity and user preferences through a web application installed in the computing device 120. In another embodiment, the user 115 enters her unique identity and user preferences through a plug-in installed in the computing device 120. In yet another embodiment, the user 115 enters her unique identity and user preferences by directly logging on to the recommendation service website.

Furthermore, the system 100 shows the user 115 getting recommendation of the product. The user 115 selects a category from which one or more products can be recommended. For example, the user 115 may select the category of footwear from the available list of category along with her unique identity. Furthermore, the recommendation service shows the entire possible sales channel through which the user 115 can buy the recommended product. The recommendation service recommends the product that are available both online and offline. In the system 100, it can be seen that the online store 125 and an offline store 130 is recommended as sales channel for one or more recommended product. In an embodiment, there can be only a single online store 125 and a single offline store 130. In another embodiment, there can be multiple online stores 125 and multiple offline stores 130.

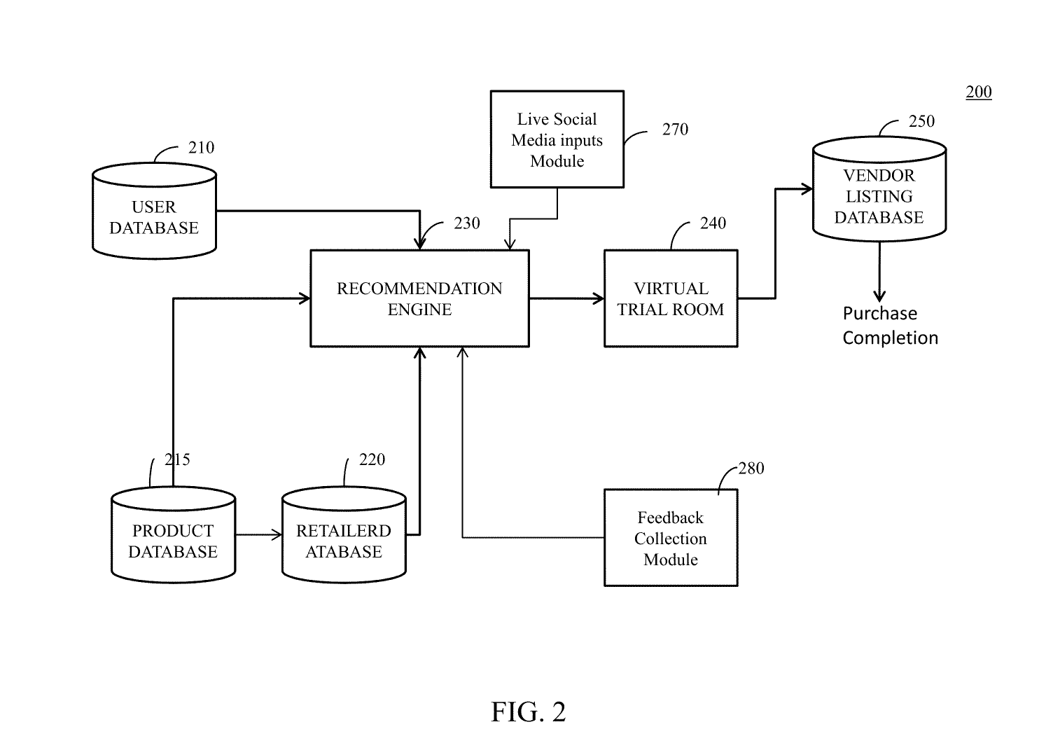

FIG. 2 illustrates a block diagram of a recommendation system 200, in accordance with various embodiments of the present invention. In an embodiment, the recommendation system 200 is computer server capable of recommending one or more products and one or more sales channel to the user 115. In another embodiment, the recommendation system 200 is plurality of computer servers capable of recommending one or more products and one or more sales channel to the user 115. In an embodiment, the recommendation system 200 is capable of handling large amount of traffic. In another embodiment, the recommendation system 200 is having a good response time. In yet another embodiment, the recommendation system 200 is able to scale large amount of data using various methods. Examples of data scaling methods are logging and measuring, horizontal scaling, load balancing, caching and the like.

Further, the recommendation system 200 includes a user database 210. The user database 210 is a collection of user data. The user database 210 contains the unique identity of each user and the preference information of the user as entered by the user. The user database 210 stores the user preference information and the unique identity of the user in a specific schema. The user database 201 furthers stores the shopping behavior history of the user 115. The user 115 can modify the user preference information to get a different recommendation. In an embodiment, the user preference information includes preference towards a particular brand, the context of usage, a preference for fit characteristics such as snug, good or loose fit. In another embodiment, the user preference information includes preference for product attributes such as high heels, laces or ankle height. In yet another embodiment, the user preference information includes product material such as leather or cloth and its related snugness of fit. In yet another embodiment, the user preference information includes preference towards trading off longevity of the product over price of the product. In yet another embodiment, the user can store existing products in the digital closet to provide information on preferences on style, design, construction and make.

The system 200 is configured to provide user 115 with provisions to change the preferences for every shopping experience. In yet another embodiment, the user preference could change as she may be buying the product for some one else. In yet another embodiment, the user preference information includes the location from which the user is willing to buy the product. In yet another embodiment, the user preference information includes combination of one or more features listed above. For example, the user preference information includes the user can wear a low or medium heel, needs arch support for her sports shoes and ASICS and BROOKS are her preferred running shoe brands . The user preference information is stored in the user database 210.

Furthermore, the recommendation system 200 includes a retailer database 220. The retailer database 220 is a collection of data of retailers. The retailer database 220 contains a list of products available with the plurality of retailers. The retailer database is configured to receive inputs for operations such as modifying the list of products in the retailer database 220, deleting or adding one or more products in the list. In an embodiment, the retailer database 220 is updated when a new retailer is added to the list. In another embodiment, the retailer database 220 is updated when an existing retailer withdraws his service from the recommendation system. In yet another embodiment, the retailer database is configured to update automatically at regular intervals. The retailer database 220 is further configured to update when multiple channels such as online or physical store options are created for the same retailer.

Furthermore, the recommendation system 200 includes a product database 215 which contains a master data base of all the products available in the industry. All products sourced through different manufacturers, brands and retailers are stored in the product database 215. Each product listed in the product database contains detailed information regarding the attributes, physical dimensions, photographs and usage model of the product. The retailer database 220 and product database 215 are configured to communicate with each other. Product database 215 is usually the super set of the data in the retailer database.

Furthermore, the recommendation system 200 includes a recommendation engine 230. The recommendation engine 230 recommends one or more products to the user 115 for every shopping event based on the information received from the user database 210, the shopping context information received from the user computing device 120 for the current shopping event and the product list obtained from the product database 215. The recommendation engine 230 is configured to correlate the products in the product database 215 with the user information based on the at least context information, preference information, user location information, expert opinion information and the dimension information associated with the user.

Based on the correlation of the available products with the shopping context mentioned by the user and her preferences, the recommendation engine 230 is configured to generate a personalized & customized catalog of most relevant products suggested to the user for one event of shopping. The shopping context as described herein refers to identifying the purpose of shopping by the user based on one or more parameters. The shopping context information is collected for every event of shopping by the kiosk 110 or the profiler application) 11 installed on the user computing device 120 and communicated to the recommendation engine 200 along with user preferences.

Furthermore, the recommendation system 200 includes a virtual trial room 240. The user 115 can try one or more recommended products in the virtual trial room 240. The virtual trial room 240 is a computer generated two or three-dimensional representation of the user 115 with an appearance with the recommended product and/or contains qualitative and quantitative fitting information of the product in a visual form. The virtual trial room 240 has a database where it captures the defining features of the person, defining features of the recommended product and a means to integrate and display the picture representing the user 115 wearing the recommended product for cosmetic, health and fitting feedback.

Further, the virtual trail room 240 is configured to generate at least a two-dimensional or a three-dimensional image of the user based on the digital profile stored in the user database 210. The virtual trail room 240 is further configured to collect opinion from live social media inputs module 270 to modify the final recommendation from recommendation engine 230. In another embodiment the virtual trial room 240 graphically overlay the two products to show case comparison. In another embodiment the virtual trial room is enabled by creating an “avatar” of the person's body or body features as well as creating a virtual digital replica of the product that is kept in the shopping catalog. The virtual trial room 240 then matches the product to the users avatar by personal body and product dimensions, wherein the ‘avatar’ is stored as the digital profile in the user database 210.

Furthermore, the recommendation system 200 includes a retailer listing database 250, where one or more sales channel is recommended for the recommended one or more products. The sales channel can be an online store or an offline store. For example, for the recommended product, the recommendation system shows one or more online store and one or more offline store. The user 115 can select the convenient recommended product and the recommended sales channel.

Furthermore, the recommendation system 200 includes a surveillance database 260 (not shown in the Figure). The surveillance database 260 monitors the recommendation system 200. The surveillance database 260 monitors the shopping behavior of the user 115, preferences, as well as factors of shopping such as conversion rate, efficiency of the recommendation system, highest selling retailers and the like.

Furthermore, the recommendation system 200 includes a feedback collection module 280 that is configured to collect errors and changes reported from the virtual trial room 240 to be reported back to the recommendation engine 230 for a new iteration of the recommendation.

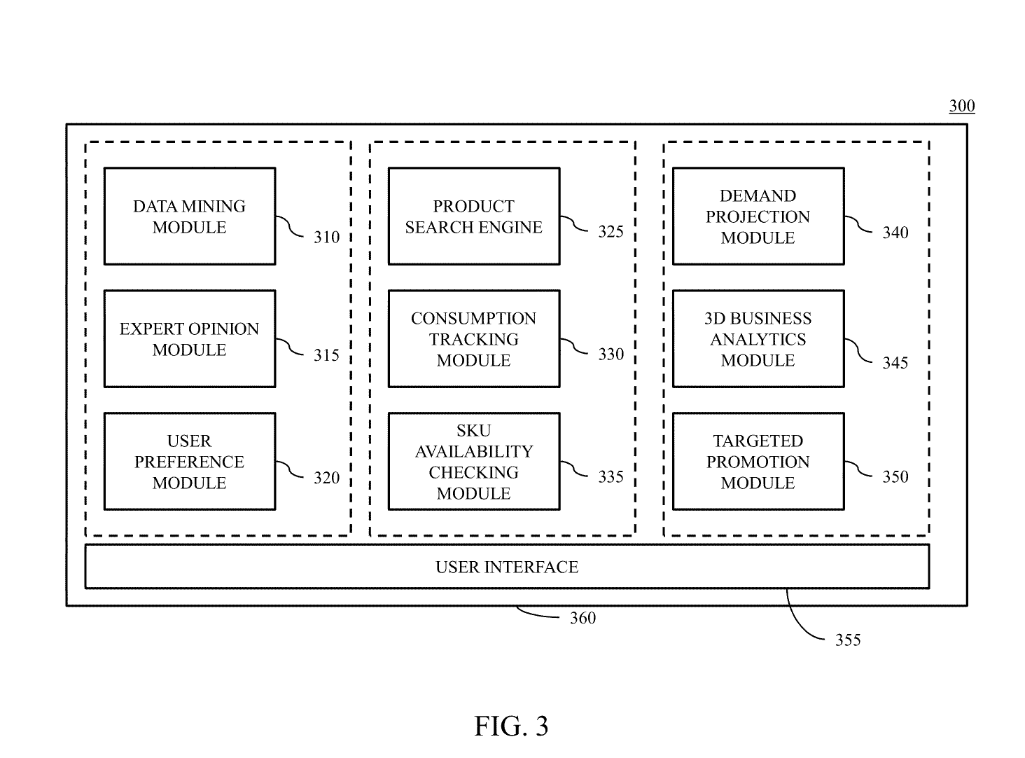

FIG. 3 illustrates components of recommendation engine, in accordance with various embodiments of the present invention. The recommendation engine 360 is the enlarged view of the recommendation engine 230. The recommendation engine 360 includes a data-mining module 310. The data-mining module 310 mines shopping behavior, product information and consumer information from the user, shopping history, and products databases. In an embodiment, the data-mining module 310 mines the data from the previous buying history of the user to find a pattern of buying. In another embodiment, the data-mining module 130 mines the data from social networking sites, blogs, news sites to collect the trend and popularity of the product.

Furthermore, the recommendation engine 360 includes an expert opinion module 315, the expert opinion module 315 generates expert opinions. The expert opinions are generated for increasing the quality of the recommendation. The expert opinion module 315 contains opinions from experts in the particular field. For example, podiatrists, shoe design/technologists for footwear retail vertical. The expert opinion module 315 also contains objective calculation and prediction of the product's usefulness for particular set of user needs

Furthermore, the recommendation engine 360 includes a user preference module 320. The user preference module 320 contains user preference information. The user preference information can be preference for a particular brand, user preference against a particular brand and the like. In an embodiment, the user preference module 320 and the user database 210 are the same. In another embodiment, the user preference module 320 and the user database 210 are different.

Furthermore, the recommendation engine 360 includes a product search engine 325. The product search engine 325 searches for the most relevant product based on the given user shopping context and preferences information. In an embodiment, the product search engine 325 rates, ranks and displays the top products based on the user shopping context and preferences information. In another embodiment, the product search engine 325 maps one or more products to user needs by tagging each product to different needs. In yet another embodiment, the product search engine 325 quantitatively positions the product on different consumer purchase decision variables. In another embodiment, the product search engine 325 maps the products based on usage model provided by the expert module 315

Furthermore, the recommendation engine 360 includes a consumption-tracking module 330. The consumption-tracking module 330 tracks the consumption of the recommended products using a data recorder. The data recorder collects information on every product purchase made by the user based on the recommendations made by recommendation engine 360. The said information is collected for every attempt of shopping and is communicated to the retailers in the retailer database 220. The consumption-tracking module 330 uses the information provided by data recorder to manage the product inventory. Consumption behavior captured by consumption-tracking module 330 is also communicated to a targeted promotion module 350 as described in the later sections.

Furthermore, the recommendation engine 360 includes a stock keeping unit (SKU) availability-checking module 335. The SKU availability checking module 335 checks if the recommended one or more products are available with one or more vendors. The sales channel is recommended to the user 115 after checking with SKU availability checking module 335. The features of SKU availability-checking module 335 use point-of-sale and enterprise-resources-planning software plug-ins to transfer the inventory knowledge at the retailer to the recommendation engine platform. In an embodiment, the availability check is done in real time. In yet another embodiment, the availability check is done on a scheduled time regularly.

Furthermore, the recommendation engine 360 includes a demand projection module 340. The demand projection module 360 projects the existing trend and the demand for the recommended one or more products. The demand-projecting module 360 also projects the demand and the trend of the recommended sales channel. In one embodiment, this information could be used by the product brands or the retailers for inventory/manufacturing planning In another embodiment, this information could be used by the user for consumption.

Furthermore, the recommendation engine 360 includes a 3D business analytics module 345. The 3D business analytics module 345 analyzes the product consumption and shopping pattern in time-domain. The 3D business analytics module 345 allows the shopping pattern to be tracked in the three-dimensional space where the user identity and preference can be tracked on a time-domain.

Furthermore, the recommendation engine 360 includes a targeted promotion module 350. The targeted promotion module 350 helps the recommendation engine 360 to target small sets of users with most relevant products using the information provided by 3D analytics data 345 and consumption tracking module 330. For example, the targeted promotion module 350 can target the shoe with a trendy pattern to a youth when his/her shoes are due for a change

Additionally, the components in the recommendation engine 360 are coupled to each other for generating effective and efficient product and sales channel recommendation. For example, the recommendation unit 360 recommends one or more sports shoe based on the user need by using ,product search engine, data mining, expert opinion module, and SKU availability engine to help the shopper buy the right sport shoes at right retailer.

Furthermore all these modules(310-360) are configured to be accessed through a unique user interface 355. In one embodiment a unique implementation of a tag cloud is provided to capture user inputs by the user interface 355. In another embodiment a special voice assist is provided to collect data in the expert opinion module 315. In yet another embodiment a map based interface is provided to the user 115 to view information provided by the SKU availability checking module 335.

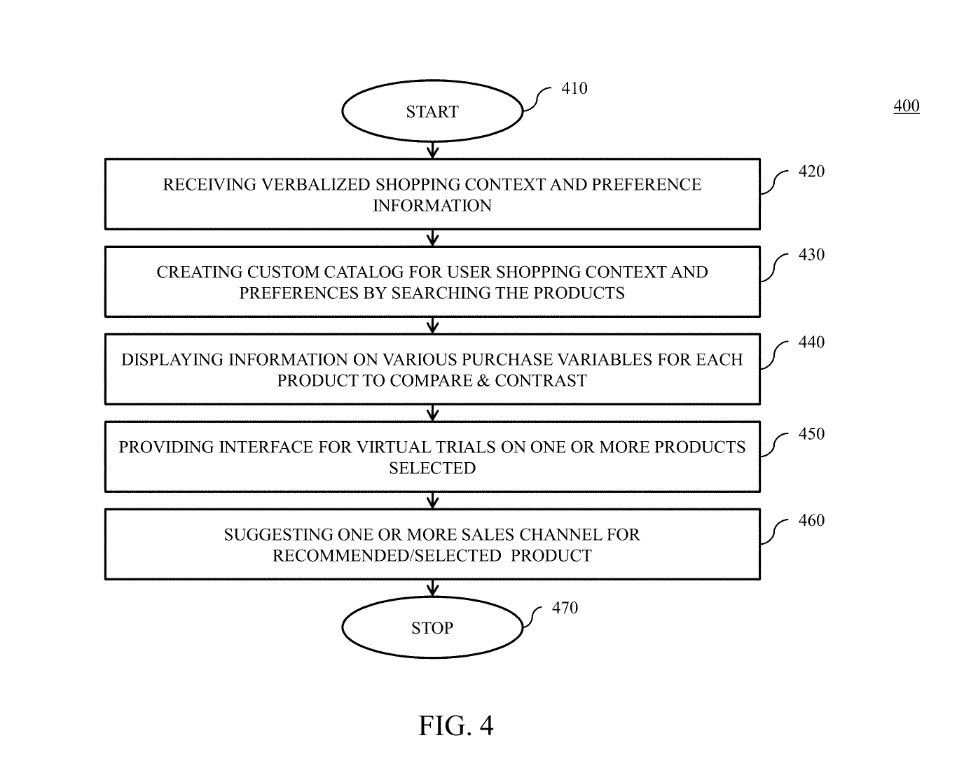

FIG. 4 illustrates a flowchart for recommending products and sales channel to a user, in accordance with various embodiments of the present invention. The flowchart 400 initiates at step 410. At step 420, the recommendation system 200 asks user to verbalize shopping context in terms of needs, product attributes, preferences, and usage model for the current shopping event. The combination of inputs is captured as information about the shopping context of the user for the current shopping event.

Further, at step 430, the recommendation system 200 receives the shopping context from step 420 and searches for the right product(s) for the given shopping context and user needs. The matching products are rated & ranked. The top products are listed as a custom catalog for the user.

Furthermore, at step 440, the recommendation system 200 receives the custom catalog for the user's shopping trip and presents to the user for product selection. Furthermore, at step 450, the recommendation system 450 allows the user to trial and tests one or more recommended item virtually using various techniques as described previously. Furthermore, at step 460, the recommendation system 460 recommends user one or more sales channel for one or more recommended products and record the sales channel and product that was bought by the customer. At step 460, the flowchart terminates.

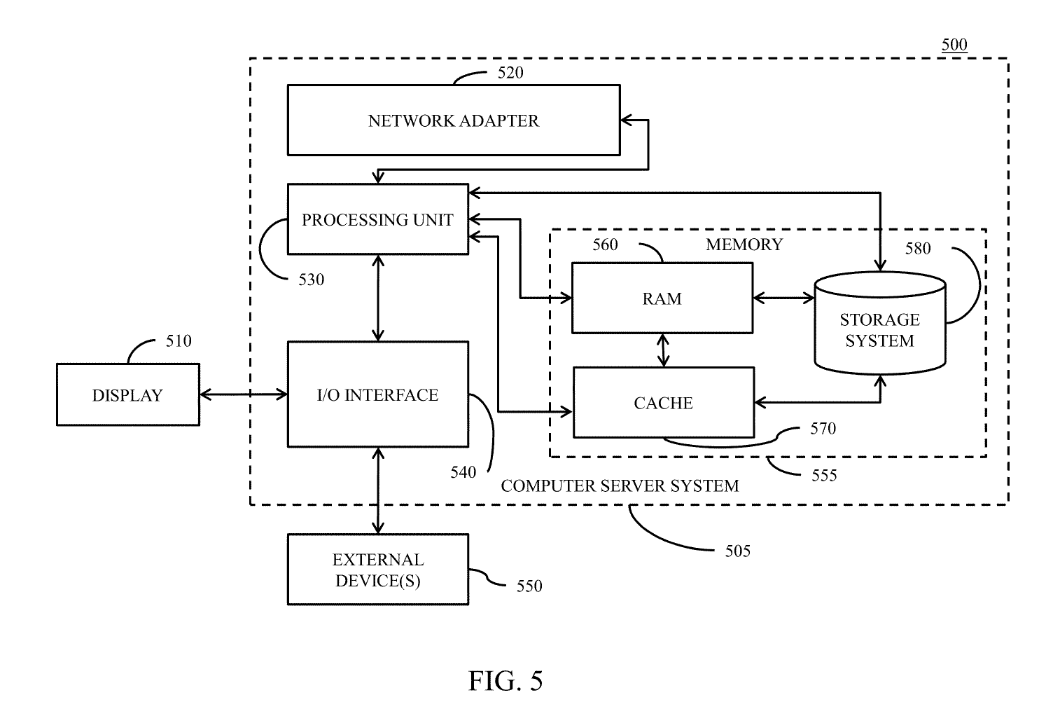

FIG. 5 illustrates a block diagram of a computer node 500 of the recommendation engine 230, in accordance with various embodiments of the present invention. The computer node 500 of the recommendation engine 230 includes a computer server 505 that is operational with numerous other general purpose or special purpose computing system environments or configurations. Examples of well-known computing systems, environments, and/or configurations that may be suitable for use with computer server 505 include, but are not limited to, personal computer systems, server computer systems, cloud computing services, thin clients, thick clients, hand-held or laptop devices, multiprocessor systems, microprocessor-based systems, set top boxes, programmable consumer electronics, network PCs, minicomputer systems, mainframe computer systems, and the like.

In FIG. 5, the computer server 505 in the computer node 500 of the recommendation engine 230 is shown in the form of a general-purpose computing device. The components of computer server 505 include, but are not limited to, processing unit 530, a system memory 555, a network adapter 520, an input-output (I/O) interface 540 and one or more buses that couples various system components to processing unit 530.

The one or more buses represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer server 505 typically includes a variety of computer system readable media. Such media may be any available media that is accessible by computer server 505, and includes both volatile and non-volatile media, removable and non-removable media. In an embodiment, the system memory 555 includes computer system readable media in the form of volatile memory, such as random access memory (RAM) 560 and cache memory 570. Computer server 505 may further include other removable/non-removable, non-volatile computer system storage media. In an embodiment, the system memory 555 includes a storage system 580.

Computer server 505 can communicate with one or more external devices 550 and a display 510, via input-output (I/O) interfaces 540. In addition, computer server 505 can communicate with one or more networks such as a local area network (LAN), a general wide area network (WAN), and/or a public network (for example, the Internet) via the network adapter 520.

It can be understood by one skilled in the art that although not shown, other hardware and/or software components can be used in conjunction with the computer server 505. Examples, include, but are not limited to microcode, device drivers, redundant processing units, external disk drive arrays, RAID systems, tape drives, data archival storage systems, and the like.

The advantage of using the recommendation system 200 is that the user 115 will have a quality shopping experience. Quality of the experience is defined as expectations and needs that are catered during the shopping process. When the recommendation system is used the user will get all the information he or she wants before the product purchase to make the right purchase decision. Satisfaction of buying the right product from right place increases the quality of shopping experience.

Another advantage of using recommendation system 200 is that the efficiency of the shopping is enriched. Shopping is an activity that needs resources to be spent to procure and consume a good/service. The resources used by shoppers can be classified mainly into time, energy and money. The other advantage of using recommendation system 200 is that the shopping context is enriched. For example, the recommendation system 200 recommends right formal shoe model to wear for occasion as well as to use with a pair of jeans in the shortest turnaround time while the same shoe model search may take five physical trials in three different store in two commercial districts taking the user more than three to four hours along with commute expense and energy to try fifteen different pair of shoes.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer implemented method for recommending relevant products and at least a sales channel to a user, the computer implemented method comprising:
a. executing one or more instructions on a processor;
b. containing instructions that, when executed causes to perform the computer a set of steps comprising:
i. receiving shopping context information, user preferences, at least one product related preference and the body profile information relative to the product from the user;
ii. searching a product database based on at least one one or more shopping context information, preference information and the body profile information received from the user;
iii. retrieving a list of most relevant products;
iv. presenting the list of most relevant products along with at least an expert opinion, wherein the expert opinion is collected from a plurality of sources;
v. providing an interface for testing one or more recommended products virtually to determine the look and fit of the product over one or more body parts and
vi. suggesting one or more sales channel for the one or more recommended products virtually tested by the user, wherein the one or more sales channels are suggested after determining the availability of the product.

2. The computer implemented method as claimed in claim 1, wherein the body profile information comprises at least the digitized image or dimensional measurement of one or more body parts;

3. The computer implemented method as claimed in claim 1, wherein the user preference information comprises details on different purchase decision variables such as style, construction, usage, fit, design, price, color, brands, designer, attire, costume, lifestyle, and values;

4. The computer implemented method as claimed in claim 1, wherein the method further comprises the step of collecting feedback corresponding to the relevant products from at least a social network before recommending the sales channel.

5. The computer implemented method as claimed in claim 1, wherein the user preference information comprises at least the fashion, health condition, athletic requirements for footwear/apparel.

6. The computer implemented method as claimed in claim 1, wherein the list of relevant products is generated as a personalized and customized product catalog based on the user shopping context and user preferences.

7. The computer implemented method as claimed in claim 1, wherein the user preference information further comprises geo-location of the user.

8. The computer implemented method as claimed in claim 1, wherein the at least one sales channel is recommended to the user based on proximity to the geo-location of the user.

9. The computer implemented method as claimed in claim 1, wherein recommending one or more products comprises selecting plurality of products from the product database by mapping and correlating the product attributes with the at least user shopping context, user preferences and user body profile information.

10. The computer implemented method as claimed in claim 1, further comprises storing qualitative and quantitative feedback about the products in different formats such as reviews, scores, tags.

11. The computer implemented method as claimed in claim 1, further comprising presenting expert opinions and feedback from social network for a particular product recommended for the shopping context.

12. The computer implemented method as claimed in claim 1, wherein the availability of the plurality of recommended products with the retailers is stored in a vendor listing database.

13. A method for recommending a product and sales channel to a user, the method comprising:
i. receiving shopping context information, user personal preferences, at least one product related preference and the body profile information relative to the product from the user;
ii. searching a product database based on at least one context information, shopping need and preference information received from the user;
iii. retrieving a list of most relevant products;
iv. presenting the list of most relevant products along with at least an expert opinion, wherein the expert opinion is collected from a plurality of sources;
v. providing an interface for testing one or more recommended products virtually to determine the look and fit of the product over one or more body parts and
vi. suggesting one or more sales channel for the one or more recommended products virtually tested by the user, wherein the one or more sales channels are suggested after determining the availability of the product.

14. A system for recommending a product and sales channel to a user, the system comprising:
a. a user database for storing at least a user shopping behavior history, a product preference information ,and a body profile information, wherein the body profile information comprises at least the dimension of the body part to be fit for the product or a digital image of the body part;
b. a product database for storing plurality of products available with plurality of vendors stored in a vendor listing database;
c. a recommendation engine for recommending plurality of products and the sales channel to the user wherein the recommendation is based on correlating the product database with information received from the user database;
d. a virtual trial room for trying the plurality of products on the digital profile by the user;
where in the sales channel is recommended based on the information on availability of product received from vendor listing database.

15. The system of claim 13, wherein the system comprises a profiler application to collect the at least user shopping context information, user preference information and the body profile information.

16. The system of claim 13, wherein the system further comprises a targeted promotion module for creating targeted advertisement campaigns for the user.

17. The system of claim 13, wherein the system further comprises a business analytics module for providing shopping behavior of the user in three dimensions namely identity, context and time.
